(19) United States
(12) Patent Application Publication
(10) Pub. No.: US 2010/0075243 A1
(43) Pub. Date: Mar. 25, 2010

(54) TONER FOR ELECTROPHOTOGRAPHY, AND TWO-COMPONENT DEVELOPER AND IMAGE FORMING METHOD USING THE TONER

(76) Inventors: Naohito SHIMOTA, Numazu-shi (JP); Naohiro Watanabe, Shizuoka-ken (JP); Hiroshi Yamashita, Numazu-shi (JP); Tsuyoshi Sugimoto, Mishima-shi (JP); Masaki Watanabe, Numazu-shi (JP); Satoshi Kojima, Numazu-shi (JP); Shinichi Wakamatsu, Numazu-shi (JP); Tsuneyasu Nagatomo, Numazu-shi (JP)

Correspondence Address: OBLON, SPIVAK, MCCLELLAND MAIER & NEUSTADT, L.L.P., 1940 DUKE STREET, ALEXANDRIA, VA, 22314, US

(21) Appl. No.: 12/564,395

(22) Filed: Sep. 22, 2009

(30) Foreign Application Priority Data
Sep. 24, 2008 (JP) 2008-244323

(51) Int. Cl. G03G 13/20; G03G 9/087

(52) U.S. Cl. 430/109.4; 430/124.1

(57) ABSTRACT

A toner for electrophotography, including a release agent; a binder resin; a colorant; and an external additive, wherein the binder resin is a polyester resin, and wherein the toner has a loss on heat not greater than 0.40% by weight at 165° C. and a difference between a loss on heat at 200° C. and the loss on heat at 165° C. not greater than 0.50% by weight, and includes a n-paraffin in an amount not less than 3% by weight.

### BACKGROUND OF THE INVENTION

1. Field of the Invention

The present invention relates to a developer used for electrophotographic image forming process.

2. Discussion of the Background

Recently, electrophotographic image forming methods have been used in large image and high speed printing fields such as offset printings. One of the objects of the electrophotographic image forming methods is to fix images on transfer media at lower energy.

Accordingly, it is essential that a toner has a lower fixable temperature and hot offset resistance. In addition, a toner needs to have aggregation resistance when stored at normal temperature. Namely, the toner needs to melt instantly when used and have aggregation resistance when stored at normal temperature at the same time. Therefore, it is often suggested that polyester resins advantageously used for low temperature fixation are used to lower the fixable temperature.

As methods of preventing hot offset, a method of putting a polymeric resin into a toner to control the viscoelasticity thereof and a method of using a release agent such as waxes to increase the releasability thereof from fixing members are well known.

Particularly, as for the release agent, as disclosed Japanese Patent No. 3376019, it is suggested that paraffin waxes and waxes having a specific melting point when measured by DSC method are used, and they have good releasability. As mentioned above, in high-speed printing fields, even when a large number of images having a large image area are printed, they are required to have quality as high as that of the initial images.

However, the paraffin waxes having high volatile contaminate members of image forming apparatus and transfer media when a large number of images are produced with a toner including the waxes.

Japanese published unexamined publication No. 2005-331925 discloses a toner including two resins, either of which includes a wax having a derivative of hydroxy stearic acid, glycerin fatty acid ester and a vinyl group, an acid value of 10 to 80, and a specific loss on heat at 220° C. to improve storage stability, carrier spent and filming over a photoreceptor. However, the wax does not always need to satisfy the specific loss on heat at 220° C., depending on the kind of wax or when the toner is granulated in an aqueous medium.

Even when the specific loss on heat at 220° C. is satisfied, members of image forming apparatus are occasionally contaminated and transfer media do not have sufficient separativeness. Even when the specific loss on heat at 220° C. is not satisfied, the contamination of the members are effectively prevented, occasionally.

Japanese published unexamined publication No. 2005-331925 also discloses when paraffin wax having high melting point is simply used, the resultant toner is difficult to have desired releasability, resulting in occurrence of hot offset deterioration of image quality such as lower glossiness.

The waxes are mostly esters of higher fatty acids and higher alcohol, and such waxes, e.g., candelilla waxes, carnauba waxes, myristic waxes, rice waxes, bee waxes, etc. are mostly used for toners as well. The ester waxes range widely and even one of them is likely to have comparatively wide properties. Meanwhile, however, it is suggested hydrocarbon waxes are used instead of natural (ester) waxes. The present inventors previously disclose in Japanese published unexamined publication No. 2007-241002 using a polyester resin and a modified polyester resin, and a wax selected from the group consisting of paraffin waxes, polyethylene waxes and polypropylene waxes having a melting point of from 50 to 90° C.

Simply specifying the melting point of a wax or using a sole wax having a sole property cannot prepare a toner not contaminating inner apparatus and having desired fixability.

Full-color images having high image area ratios are mostly printed at high speed, and a transfer medium needs reliably separating from a heating medium at high speed. Therefore, it is essential that a toner has releasability and inner contamination resistance with a wax.

Because of these reasons, a need exists for a toner improving the separability of a transfer medium at high speed printing speed, having both offset resistance and storageability at normal temperature, and preventing inner contamination of image forming apparatus.

### SUMMARY OF THE INVENTION

Accordingly, an object of the present invention is to provide a toner improving the separability of a transfer medium at high speed printing speed, having both offset resistance and storageability at normal temperature, and preventing inner contamination of image forming apparatus.

Another object of the present invention is to provide an image forming apparatus using the toner.

These objects and other objects of the present invention, either individually or collectively, have been satisfied by the discovery of a toner for electrophotography, comprising:

a release agent;

a binder resin;

a colorant; and

an external additive,

wherein the binder resin is a polyester resin, and wherein the toner has a loss on heat not greater than 0.40% by weight at 165° C. and a difference between a loss on heat at 200° C. and the loss on heat at 165° C. not greater than 0.50% by weight, and includes a n-paraffin in an amount not less than 3% by weight.

These and other objects, features and advantages of the present invention will become apparent upon consideration of the following description of the preferred embodiments of the present invention taken in conjunction with the accompanying drawings.

### BRIEF DESCRIPTION OF THE DRAWINGS

Various other objects, features and attendant advantages of the present invention will be more fully appreciated as the same becomes better understood from the detailed description when considered in connection with the accompanying drawings in which like reference characters designate like corresponding parts throughout and wherein:

FIG. 1 is a schematic view illustrating an embodiment of the image forming apparatus of the present invention;

FIG. 2 is a schematic view illustrating another embodiment of the image forming apparatus of the present invention; and

FIG. 3 is a schematic view illustrating the tandem image developer in FIG. 2.

### DETAILED DESCRIPTION OF THE INVENTION

The present invention provides a toner improving the separability of a transfer medium at high speed printing speed, having both offset resistance and storageability at normal temperature, and preventing inner contamination of image forming apparatus. Particularly, the present invention relates to a toner for electrophotography, comprising:

a release agent;

a binder resin;

a colorant; and

an external additive,

wherein the binder resin is a polyester resin, and wherein the toner has a loss on heat not greater than 0.40% by weight at 165° C. and a difference between a loss on heat at 200° C. and the loss on heat at 165° C. not greater than 0.50% by weight, and includes a n-paraffin in an amount not less than 3% by weight.

The toner preferably uses a polyester resin as a binder resin, and has a loss on heat not greater than 0.40% by weight at 165° C. and a difference between a loss on heat at 200° C. and the loss on heat at 165° C. not greater than 0.50% by weight. Namely, not only less undesired materials under an environment around preset temperature of the fixer but also a small gradient to two temperatures are essential. This is because the loss on heat has a threshold exponentially varying against temperature, and only the specification at one temperature does not sufficiently prevents the members from being contaminated. Further, even when a loss on heat at 220° C. is large, the recent low-temperature fixing image forming apparatus does not have inner contamination if the requirements of the present invention are satisfied.

In addition, the toner including a n-paraffin in an amount not less than 3% by weight has a desired releasability and prevents inner contamination of the apparatus.

When the loss on heat to two temperatures has a gradient not greater than 2.0, the release agent can be increased to improve releasability of a transfer medium without contaminating inner apparatus because of not exceeding a threshold temperature of the loss on heat.

Paraffin highly depends on temperature, for example, even when paraffin crude oil is slightly cooled when transported through pipe lines, the paraffin is precipitated in the shape of a cotton in the crude oil, resulting in rapid increase of transportation cost. This is adversely preferable for a toner, however, lower components having a small number of carbon atoms are likely to work as a solvent or a melting agent for higher components having a large number of carbon atoms. Therefore, it is essential to choose paraffin wax suitable for the present invention.

It is essential in the present invention that the release agent is a paraffin wax having a DSC chart peak termination temperature of from 80 to 95° C. in terms of compatibility with the polyester resin. In addition, there is a correlation between the threshold temperature of the loss on heat variation of from 165 to 200° C. and the peak termination temperature. Therefore, this improves prevention of inner contamination of the apparatus and releasability of a transfer medium.

The toner of the present invention is granulated in an aqueous medium.

A toner prepared by aqueous granulation methods, using a polyester resin, has low-temperature fixability and a uniform small particle diameter, and therefore it is capable of satisfying both of low-temperature fixability and production of high-quality images required in high-speed printing fields.

Further, a two-component developer including a magnetic particulate carrier and the above-mentioned toner having an average particle diameter of from 3 to 6 μm is preferably used. This is because the two-component developer is suitable in high-speed printing fields and the toner having an average particle diameter of from 3 to 6 μm can cover an image area with an amount thereof less than those of other toners having different particle diameters. The less amount thereof improves inner contamination of the apparatus and lowers the height of the images to have high quality.

It is essential that an image forming method including a process of forming a latent image on each of plural electrostatic latent image bearer, a process of developing each of the latent images formed on each of the electrostatic latent image bearer with the above-mentioned developer including a different color toner to form toner images having each color on each of the electrostatic latent image bear, a process of transferring toner images having each color on each of the electrostatic latent image bear onto an image forming substrate through an intermediate transferer and a process of fixing the toner images on the image forming substrate feeds the image forming substrate at a speed not less than 250 mm/sec.

Tandem intermediate transfer methods are most suitable for high speed printing to produce high quality images, and a combination with the toner or developer of the present invention exerts a good effect when producing images at a feeding speed not less than 250 mm/sec of the image forming substrate.

Known materials or combinations thereof can be used for forming the toner of the present invention, provided they satisfy the requirements thereof.

Organic solvents for use in the aqueous granulation method of present invention are not particularly limited, however, preferably have a boiling point less than 150° C. in terms of removability.

Specific examples thereof include toluene, xylene, benzene, carbon tetrachloride, methylene chloride, 1,2-dichloroethane, 1,1,2-trichloroethane, trichloroethylene, chloroform, monochlorobenzene, dichloroethylidene, methylacetate, ethylacetate, methylethylketone and methylisobutylketone. Particularly, toluene, xylene, benzene, carbon tetrachloride, methylene chloride, 1,2-dichloroethane and chloroform are preferably used, and methylacetate is more preferably used. These can be used alone or in combination.

100 parts by weight of the toner constituents are preferably dissolved or dispersed in 40 to 300 parts by weight, more preferably from 60 to 140 parts by weight, and furthermore preferably from 80 to 120 parts by weight of the organic solvent.

Toner constituents are not particularly limited besides a binder resin, a colorant and a release agent, however, the binder resin includes at least a monomer, a polymer, a compound having an active hydrogen group or a polymer reactable with the active hydrogen group, and may include other optional components.

### <Binder Resin>

The binder resin includes a polyester resin.

### —Polyester Resin—

The polyester resins are not particularly limited, and can be prepared by dehydrating and condensing polyols and polycarboxylic acids.

Specific examples of the polyols include diols such as ethylene glycol, propylene glycol, 1,3-butanediol, 1,4-butanediol, 2,3-butanediol, diethylene glycol, triethylene glycol, 1,5-pentanediol, 1,6-hexanediol, neo-pentyl glycol, 2-ethyl-1,3-hexanediol, hydrogenated bisphenol A ethyleneoxide modified bisphenol A and propyleneoxide modified bisphenol A.

In order to crosslink polyester resins, tri- or more valent alcohols such as sorbitol, 1,2,3,6-hexanetetrol, 1,4-sorbitan, pentaerythritol, dipentaerythritol, tripentaerythritol, 1,2,4-butanetriol, 1,2,5-pentanetriol, glycerol, diglycerol, 2-methylpropanetriol, 2-methyl-1,2,4-butanetriol, trimethylolethane, trimethylolpropane, 1,3,5-trihydroxybenzene, etc. are preferably combined with the diols.

Specific examples of dicarboxylic acids in the polycarboxylic acids include benzene dicarboxylic acids such as a phthalic acid, an isophthalic acid and a terephthalic acid or their anhydrides; alkyl dicarboxylic acids such as a succinic acid, an adipic acid, a sebacic acid and an azelaic acid or their anhydrides; unsaturated diacids such as a maleic acid, a citraconic acid, an itaconic acid, an alkenyl succinic acid, a fumaric acid and a mesaconic acid; unsaturated diacid anhydrides such as a maleic acid anhydride, citraconic acid anhydride, an itaconic acid anhydride and an alkenyl succinic acid anhydride; a trimellitic acid, pyromellitic acid, a 1,2,4-benzenetricarboxylic acid, a 2,5,7-naphthalenetricarboxylic acid, a 1,2,4-naphthalenetricarboxylic acid, a 1,2,4-butanetricarboxylic acid, a 1,2,5-hexanetricarboxylic acid, 1,3-dicarboxyl-2-methyl-methylenecarboxypropane, tetra(methylenecarboxyl)methane, a 1,2,7,8-octantetracarboxylic acid, an empol trimer acid, and their anhydrides and lower alkyl esters, etc.

The polyester resin preferably has an acid value of from 5 to 40 mg KOH/g, and more preferably from 10 to 30 mg KOH/g.

When less than 5 mg KOH/g, the resultant toner deteriorates in affinity with papers which are main recording media, low-temperature fixability and negative chargeability, resulting in production of deteriorated images.

When greater than 40 mg KOH/g, the resultant toner deteriorates in environment resistance against high (low) temperature and high (low) humidity, resulting in production of deteriorated images.

The polyester resin preferably includes elements soluble with tetrahydrofuran (THF), having at least one peak in a range of 3,000 to 50,000, and more preferably from 5,000 to 20,000 in a molecular weight distribution by GPC thereof in terms of the fixability and offset resistance of the resultant toner. In addition, the THF-soluble elements having a molecular weight not greater than 100,000 is preferably from 60 to 100% by weight based on total weight of the THF-soluble elements.

The polyester resin preferably has a glass transition temperature (Tg) of from 55 to 80° C., and more preferably from 60 to 75° C. in terms of the storage stability of the resultant toner.

When the Tg is from 55 to 80° C., the resultant toner has good stability when stored at high temperature and good low-temperature fixability.

The binder resin may further include resins other than the polyester resin.

Specific examples thereof include polymers or copolymers of styrene monomers, acrylic monomers methacrylic monomers, etc.; polyol resins; phenol resins; silicone resins; polyurethane resins; polyamide resins; furan resins; epoxy resins; xylene resins; terpene resins; coumarone-indene resins; polycarbonate resins; petroleum resins; etc. These can be used alone or in combination.

### <Release Agent>

The release agents are not particularly limited, provided they satisfy the loss on heat and n-paraffin ratio of the present invention.

Specific examples thereof include petroleum waxes such as a paraffin wax, a microcrystalline wax and petrolatum; natural waxes such as vegetable waxes, e.g., carnauba wax, cotton wax, Japan wax and rice wax; animal waxes, e.g., bees wax and lanolin; mineral waxes, e.g., ozokelite and ceresine; synthesized hydrocarbon waxes such as Fischer-Tropsch waxes, polyethylene waxes, polypropylene waxes; synthesized waxes such as ester waxes, ketone waxes and ether waxes.

In addition, fatty acid amides such as 1,2-hydroxylstearic acid amide, stearic acid amide and phthalic anhydride imide; and low molecular weight crystalline polymers such as acrylic homopolymer and copolymers having a long alkyl group in their side chain, e.g., poly-n-stearyl methacrylate, poly-n-laurylmethacrylate and n-stearyl acrylate-ethyl methacrylate copolymers, can also be used. The release agent can be used alone or in combination.

The toner preferably includes the release agent in an amount not less than 1 and less than 30 parts by weight, although depending on the properties of the release agent. When less than 1 part by weight, the resultant toner occasionally deteriorates in hot offset resistance. When not less than 30 parts by weight, the resultant toner occasionally deteriorates in filming resistance and produces foggy images.

### <Colorant>

Specific examples of the colorant for use in the present invention include any known dyes and pigments such as carbon black, Nigrosine dyes, black iron oxide, NAPHTHOL YELLOW S, HANSA YELLOW (10G, 5G and G), Cadmium Yellow, yellow iron oxide, loess, chrome yellow, Titan Yellow, polyazo yellow, Oil Yellow, HANSA YELLOW (GR, A, RN and R), Pigment Yellow L, BENZIDINE YELLOW (G and GR), PERMANENT YELLOW (NCG), VULCAN FAST YELLOW (5G and R), Tartrazine Lake, Quinoline Yellow Lake, ANTHRAZANE YELLOW BGL, isoindolinone yellow, red iron oxide, red lead, orange lead, cadmium red, cadmium mercury red, antimony orange, Permanent Red 4R, Para Red, Fire Red, p-chloro-o-nitroaniline red, Lithol Fast Scarlet G, Brilliant Fast Scarlet, Brilliant Carmine BS, PERMANENT RED (F2R, F4R, FRL, FRLL and F4RH), Fast Scarlet VD, VULCAN FAST RUBINE B, Brilliant Scarlet G, LITHOL RUBINE GX, Permanent Red F5R, Brilliant Carmine 6B, Pigment Scarlet 3B, Bordeaux 5B, Toluidine Maroon, PERMANENT BORDEAUX F2K, HELIO BORDEAUX BL, Bordeaux 10B, BON MAROON LIGHT, BON MAROON MEDIUM, Eosin Lake, Rhodamine Lake B, Rhodamine Lake Y, Alizarine Lake, Thioindigo Red B, Thioindigo Maroon, Oil Red, Quinacridone Red, Pyrazolone Red, polyazo red, Chrome Vermilion, Benzidine Orange, perynone orange, Oil Orange, cobalt blue, cerulean blue, Alkali Blue Lake, Peacock Blue Lake, Victoria Blue Lake, metal-free Phthalocyanine Blue, Phthalocyanine Blue, Fast Sky Blue, INDANTHRENE BLUE (RS and BC), Indigo, ultramarine, Prussian blue, Anthraquinone Blue, Fast Violet B, Methyl Violet Lake, cobalt violet, manganese violet, dioxane violet, Anthraquinone Violet, Chrome Green, zinc green, chromiumoxide, viridian, emerald green, Pigment Green B, Naphthol Green B, Green Gold, Acid Green Lake, Malachite Green Lake, Phthalocyanine Green, Anthraquinone Green, titanium oxide, zinc oxide, lithopone, etc. These can be used alone or in combination.

The toner preferably include the colorant in an amount of from 1 to 15% by weight, and more preferably from 5 to 12% by weight. When less than 1% by weight, the resultant toner deteriorates in colorability. When greater than 15% by weight, the resultant toner adversely deteriorates in opacifying power and chargeability.

The colorant for use in the present invention can be used as a masterbatch when combined with a resin.

Specific examples of the resin include styrene polymers and substituted styrene polymers such as polystyrene, poly-p-chlorostyrene and polyvinyltoluene; styrene copolymers such as styrene-p-chlorostyrene copolymers, styrene-propylene copolymers, styrene-vinyltoluene copolymers, styrene-vinylnaphthalene copolymers, styrene-methyl acrylate copolymers, styrene-ethyl acrylate copolymers, styrene-butyl acrylate copolymers, styrene-octyl acrylate copolymers, styrene-methyl methacrylate copolymers, styrene-ethyl methacrylate copolymers, styrene-butylmethacrylate copolymers, styrene-methyl α-chloromethacrylate copolymers, styrene-acrylonitrile copolymers, styrene-vinyl methyl ketone copolymers, styrene-butadiene copolymers, styrene-isoprene copolymers, styrene-acrylonitrile-indene copolymers, styrene-maleic acid copolymers and styrene-maleic acid ester copolymers; and other resins such as polymethyl methacrylate, polybutylmethacrylate, polyvinyl chloride, polyvinyl acetate, polyethylene, polypropylene, polyesters, epoxy resins, epoxy polyol resins, polyurethane resins, polyamide resins, polyvinyl butyral resins, acrylic resins, rosin, modified rosins, terpene resins, aliphatic or alicyclic hydrocarbon resins, aromatic petroleum resins, chlorinated paraffin, paraffin waxes, etc. These resins are used alone or in combination.

The masterbatch for use in the toner of the present invention is typically prepared by mixing and kneading a resin and a colorant upon application of high shear stress thereto. In this case, an organic solvent can be used to heighten the interaction of the colorant with the resin. In addition, flushing methods in which an aqueous paste including a colorant is mixed with a resin solution of an organic solvent to transfer the colorant to the resin solution and then the aqueous liquid and organic solvent are separated and removed can be preferably used because the resultant wet cake of the colorant can be used as it is. Of course, a dry powder which is prepared by drying the wet cake can also be used as a colorant. In this case, a three-roll mill is preferably used for kneading the mixture upon application of high shear stress.

### <Other Components>

The toner may include other components such as a charge controlling agent, an inorganic particulate material, a cleaning improver and a magnetic material.

Specific examples of the charge controlling agent include known charge controlling agents such as Nigrosine dyes, triphenylmethane dyes, metal complex dyes including chromium, chelate compounds of molybdic acid, Rhodamine dyes, alkoxyamines, quaternary ammonium salts (including fluorine-modified quaternary ammonium salts), alkylamides, phosphor and compounds including phosphor, tungsten and compounds including tungsten, fluorine-containing activators, metal salts of salicylic acid, salicylic acid derivatives, etc. Specific examples of the marketed products of the charge controlling agents include BONTRON 03 (Nigrosine dyes), BONTRON P-51 (quaternary ammonium salt), BONTRON S-34 (metal-containing azo dye), E-82 (metal complex of oxynaphthoic acid), E-84 (metal complex of salicylic acid), and E-89 (phenolic condensation product), which are manufactured by Orient Chemical Industries Co., Ltd.; TP-302 and TP-415 (molybdenum complex of quaternary ammonium salt), which are manufactured by Hodogaya Chemical Co., Ltd.; COPY CHARGE PSY VP2038 (quaternary ammonium salt), COPY BLUE (triphenyl methane derivative), COPY CHARGE NEG VP2036 and NX VP434 (quaternary ammonium salt), which are manufactured by Hoechst AG; LRA-901, and LR-147 (boron complex), which are manufactured by Japan Carlit Co., Ltd.; copper phthalocyanine, perylene, quinacridone, azo pigments and polymers having a functional group such as a sulfonate group, a carboxyl group, a quaternary ammonium group, etc. These can be used alone or in combination.

The content of the charge controlling agent is not particularly limited, however, preferably from 0.1 to 10 parts by weight, and more preferably from 0.2 to 5 parts by weight, based on total weight of the binder resin included in the toner.

When less than 0.1 parts by weight, the toner occasionally does not have charge controllability. When greater than 10 parts by weight, the toner has too large charge quantity, and thereby the electrostatic force of a developing roller attracting the toner increases, resulting in deterioration of the fluidity of the toner and decrease of the image density of toner images.

Specific examples of the inorganic particulate materials include silica, alumina, titanium oxide, barium titanate, magnesium titanate, calcium titanate, strontium titanate, zinc oxide, tin oxide, quartz sand, clay, mica, sand-lime, diatom earth, chromium oxide, cerium oxide, red iron oxide, antimony trioxide, magnesium oxide, zirconium oxide, barium sulfate, barium carbonate, calcium carbonate, silicon carbide, silicon nitride, etc.

The inorganic particulate materials preferably have a primary particle diameter of from 5 nm to 2 μm, and more preferably from 5 nm to 500 nm.

The toner preferably includes the inorganic particulate material in an amount of from 0.01 to 5.0% by weight, and more preferably from 0.01 to 2.0% by weight, based on total weight of the toner.

The inorganic particulate material is preferably surface-treated with a fluidity improver to improve hydrophobicity thereof and prevents deterioration of fluidity and chargeability thereof.

Specific examples of the fluidity improver include silane coupling agents, sililating agents, silane coupling agents having an alkyl fluoride group, organic titanate coupling agents, aluminium coupling agents silicone oils and modified silicone oils. Silica and titanium oxide are preferably used as hydrophobic silica and titanium oxide after surface-treated with the fluidity improver.

The cleanability improver is used to easily remove a toner remaining on a photoreceptor and a first transferer after transferred.

Specific examples of the cleanability improver include fatty acid metallic salts such as zinc stearate, calcium stearate and stearic acid; and particulate polymers prepared by a soap-free emulsifying polymerization method such as particulate polymethylmethacrylate and particulate polystyrene. The particulate polymers comparatively have a narrow particle diameter distribution and preferably have a volume-average particle diameter of from 0.01 to 1 μm.

The toner of the present invention has good low-temperature fixability and offset resistance, and produces high-quality images for long periods.

Therefore, the toner of the present invention can be used in various fields, and preferably used in electrophotographic image formation.

### —Polymerization Method (Aqueous Granulation Method)—

The polymerization method includes dissolving or dispersing toner constituents including at least a urea or urethane-combinable modified polyester resin, a colorant, a release agent and a fixing aid in an organic solvent to prepare a solution or a dispersion; dispersing the solution or dispersion in an aqueous medium to be subjected to a polyaddition reaction; and removing the solvent from the dispersion and washing the dispersion to prepare a toner

Specific examples of the urea or urethane-combinable modified polyester resin include a polyester prepolymer (A) having an isocyanate group formed by reacting a carboxyl group or a hydroxyl group at the terminal of polyester with polyisocyanate compound (PIC). A modified polyester resin formed by reacting the polyester prepolymer with a mines (B) such that the molecular chains are crosslinked and/or elongated improves hot offset resistance of the toner while maintaining low-temperature fixability thereof.

Specific examples of the polyisocyanate compound (PIC) include aliphatic polyisocyanate such as tetramethylenediisocyanate, hexamethylenediisocyanate and 2,6-diisocyanatemethylcaproate; alicyclicpolyisocyanate such as isophoronediisocyanate and cyclohexylmethanediisocyanate; aromatic diisocyanate such as tolylenedisocyanate and diphenylmethanediisocyanate; aroma aliphatic diisocyanate such as α,α,α′,α′-tetramethylxylylenediisocyanate; isocyanurate; the above-mentioned polyisocyanate blocked with phenol derivatives, oxime and caprolactam; and their combinations.

The PIC is mixed with polyester such that an equivalent ratio ([NCO]/[OH]) between an isocyanate group [NCO] and polyester having a hydroxyl group [OH] is typically from 5/1 to 1/1, preferably from 4/1 to 1.2/1 and more preferably from 2.5/1 to 1.5/1.

The number of the isocyanate groups included in a molecule of the polyester prepolymer (A) is at least 1, preferably from 1.5 to 3 on average, and more preferably from 1.8 to 2.5 on average.

When the number of the isocyanate group is less than 1 per 1 molecule, the molecular weight of the urea-modified polyester decreases and hot offset resistance of the resultant toner deteriorates.

Specific examples of the amines (B) include diamines (B1), polyamines (B2) having three or more amino groups, amino alcohols (B3), amino mercaptans (B4), amino acids (B5) and blocked amines (B6) in which the amines (B1-B5) mentioned above are blocked.

Specific examples of the diamines (B1) include aromatic diamines (e.g., phenylene diamine, diethyltoluene diamine and 4,4′-diaminodiphenyl methane); alicyclic diamines (e.g., 4,4′-diamino-3,3′-dimethyldicyclohexyl methane, diaminocyclohexane and isophoronediamine); aliphatic diamines (e.g., ethylene diamine, tetramethylene diamine and hexamethylene diamine); etc.

Specific examples of the polyamines (B2) having three or more amino groups include diethylene triamine, triethylene tetramine.

Specific examples of the amino alcohols (B3) include ethanol amine and hydroxyethyl aniline.

Specific examples of the amino mercaptan (B4) include aminoethyl mercaptan and aminopropyl mercaptan.

Specific examples of the amino acids (B5) include amino propionic acid and amino caproic acid.

Specific examples of the blocked amines (B6) include ketimine compounds which are prepared by reacting one of the amines B1-B5 mentioned above with a ketone such as acetone, methyl ethyl ketone and methyl isobutyl ketone; oxazoline compounds, etc. Among these compounds, diamines B1 and mixtures in which a diamine is mixed with a small amount of a polyamine B2 are preferably used.

The mixing ratio (i.e., a ratio [NCO]/[NHx]) of the content of the prepolymer (A) having an isocyanate group to the amine (B) is from 1/2 to 2/1, preferably from 1.5/1 to 1/1.5 and more preferably from 1.2/1 to 1/1.2.

The above-mentioned polymerization method can prepare a toner having a small particle diameter and the shape of a sphere at low environment load and cost.

Besides the modified polyester, unmodified polyester resin is included in a toner to improve low-temperature fixability and storage stability thereof.

The unmodified polyester resin preferably have a weight-average molecular weight (Mw) of from 1,000 to 30,000, and more preferably from 1,500 to 15,000. When less than 1,000, the thermostable preservability of the resultant toner occasionally deteriorates, and therefore the content of the unmodified polyester resin having weight-average molecular weight (Mw) less than 1,000 needs to be 8 to 28% by weigh. When greater than 30,000, the low-temperature fixability thereof occasionally deteriorates.

The unmodified polyester resin preferably has a glass transition temperature of from 30 to 70° C., more preferably from 35 to 60° C., and even more preferably from 35 to 50° C. When less than 30° C., the thermostable preservability of the resultant toner occasionally deteriorates. When greater than 70° C., the low-temperature fixability thereof occasionally deteriorates.

The unmodified polyester resin preferably has a hydroxyl value not less than 5 KOH mg/g, more preferably from 10 to 120 KOH mg/g, and even more preferably from 20 to 80 KOH mg/g. When less than 5 KOH mg/g, the resultant toner is occasionally difficult to have both thermostable preservability and low-temperature fixability.

The unmodified polyester resin preferably has an acid value of from 1.0 to 50.0 KOH mg/g, and more preferably from 1.0 to 30.0 KOH mg/g. The resultant toner having such an acid value is likely to be negatively charged.

A mixing ratio by weight of the polyester prepolymer having an isocyanate group to the unmodified polyester resin is preferably from 5/95 to 25/75, and more preferably from 10/90 to 25/75. When less than 5/95, the hot offset resistance of the resultant toner occasionally deteriorates. When greater than 25/75, the low-temperature fixability and the glossiness thereof occasionally deteriorate.

In the present invention, the aqueous medium preferably includes a polymeric dispersant. The polymeric dispersant is preferably a water-soluble polymer. Specific examples thereof include carboxymethylcellulose sodium, hydroxyethylcellulose, polyvinylalcohol, etc. These can be used alone or in combination.

When emulsifying or dispersing toner constituents using a liquid including them, the liquid is preferably dispersed in an aqueous medium while stirred.

The dispersion method is not particularly limited, and low speed shearing methods, high-speed shearing methods, friction methods, high-pressure jet methods, ultrasonic methods, etc. can be used. Among these methods, high-speed shearing methods are preferably used because particles having a particle diameter of from 2 to 20 μm can be easily prepared. When a high-speed shearing type dispersion machine is used, the rotation speed is not particularly limited, but the rotation speed is typically from 1,000 to 30,000 rpm, and preferably from 5,000 to 20,000 rpm. The dispersion time is not also particularly limited, but is typically from 0.1 to 5 min. The temperature in the dispersion process is typically from 0 to 150° C. (under pressure), and preferably from 40 to 98° C. Typically, the higher the temperature, the easier the dispersion.

Methods of forming parent toner particles while producing an adhesive base material include preparing an aqueous medium, preparing a liquid including toner constituents, emulsifying or dispersing the toner constituents, producing the adhesive base material, removing a solvent, synthesizing a polymer having reactivity with an active hydrogen, synthesizing a compound having an active hydrogen, etc. The aqueous medium can be prepared by dispersing a particulate resin therein. The aqueous medium preferably includes the particulate resin dispersed therein in an amount of from 0.5 to 10% by weight.

The liquid including toner constituents is prepared by dissolving or dispersing toner constituents such as a compound having an active hydrogen, a polymer having reactivity with an active hydrogen, a rheology additive, a colorant, a release agent, a charge controlling agent and an unmodified polyester resin in a solvent.

The carrier is not particularly limited, and can be selected in accordance with the purpose, however, preferably includes a core material and a resin layer coating the core material.

The core material is not particularly limited, and can be selected from known materials such as Mn—Sr materials and Mn—Mg materials having 50 to 90 emu/g; and highly magnetized materials such as iron powders having not less than 100 emu/g and magnetite having 75 to 120 emu/g for image density. In addition, light magnetized materials such as Cu—Zn materials having 30 to 80 emu/g are preferably used to decrease a stress to a photoreceptor having toner ears for high-quality images. These can be used alone or in combination.

The core material preferably has a volume-average particle diameter of from 10 to 150 μm, and more preferably from 40 to 100 μm. When less than 10 μm, a magnetization per particle is so low that the carrier scatters. When larger than 150 μm, a specific surface area lowers and the toner occasionally scatters, and a solid image of a full-color image occasionally has poor reproducibility.

The resin coating the core material is not particularly limited, and can be selected in accordance with the purpose. Specific examples of the resin include amino resins, polyvinyl resins, polystyrene resins, halogenated olefin resins, polyester resins, polycarbonate resins, polyethylene resins, polyvinyl fluoride resins, polyvinylidene fluoride resins, polytrifluoroethylene resins, polyhexafluoropropylene resins, vinylidenefluoride-acrylate copolymers, vinylidenefluoride-vinylfluoride copolymers, copolymers of tetrafluoroethylene, vinylidenefluoride and other monomers including no fluorine atom, and silicone resins. These can be used alone or in combination.

Specific examples of the amino resins include urea-formaldehyde resins, melamine resins, benzoguanamine resins, urea resins, polyamide resins, epoxy resins, etc. Specific examples of the polyvinyl resins include acrylic resins, polymethylmethacrylate resins, polyacrylonitirile resins, polyvinyl acetate resins, polyvinyl alcohol resins, polyvinyl butyral resins, etc. Specific examples of the polystyrene resins include polystyrene resins, styrene-acrylic copolymers, etc. Specific examples of the halogenated olefin resins include polyvinyl chloride resins, etc. Specific examples of the polyester resins include polyethyleneterephthalate resins, polybutyleneterephthalate resins, etc.

An electroconductive powder may optionally be included in the toner. Specific examples of such electroconductive powders include, but are not limited to, metal powders, carbon blacks, titanium oxide, tin oxide, and zinc oxide. The average particle diameter of such electroconductive powders is preferably not greater than 1 μm. When the particle diameter is too large, it is hard to control the resistance of the resultant toner.

The resin layer can be formed by preparing a coating liquid including a solvent and, e.g., the silicone resin; uniformly coating the liquid on the surface of the core material by a known coating method; and drying the liquid and burning the surface thereof. The coating method includes dip coating methods, spray coating methods, brush coating method, etc.

Specific examples of the solvent include, but are not limited to, toluene, xylene, methyl ethyl ketone, methyl isobutyl ketone, cellosolve butyl acetate, etc.

Specific examples of the burning methods include, but are not limited to, externally heating methods or internally heating methods using fixed electric ovens, fluidized electric ovens, rotary electric ovens, burner ovens, microwaves, etc. The carrier preferably includes the resin layer in an amount of from 0.01 to 5.0% by weight. When less than 0.01% by weight, a uniform resin layer cannot be formed on the core material. When greater than 5.0% by weight, the resin layer becomes so thick that carrier particles granulate one another and uniform carrier particles cannot be formed.

The content of the carrier in the two-component developer is not particularly limited, can be selected in accordance with the purpose, and is preferably from 90 to 98% by weight, and more preferably from 93 to 97% by weight.

The image forming method of the present invention preferably includes at least an electrostatic latent image forming process, a development process, a transfer process and a fixing process; more preferably a cleaning process; and optionally includes other processes such as a discharge process, a recycle process and a control process.

The image forming apparatus of the present invention preferably includes at least an electrostatic latent image bearer, an electrostatic latent image former, an image developer, a transferer and a fixer; more preferably a cleaner; and optionally includes other means such as a discharger, a recycler and a controller.

The image forming method of the present invention can be performed by the image forming apparatus of the present invention, the electrostatic latent image forming process, the developing process, the transferring process, the protection layer forming process, the fixing process are performed with the electrostatic latent image former, the image developer, the transferer, the protectant applicator and the fixer, respectively. The other optional processes can be performed with the optional means mentioned above.

The electrostatic latent image forming process is a process of forming an electrostatic latent image on a photoreceptor.

The material, shape, structure, size, etc. of the photoreceptor are not particularly limited, and can be selected from known electrostatic latent image bearers. However, the electrostatic latent image bearer preferably has the shape of a drum, and the material is preferably an inorganic material such as amorphous silicon and serene, and an organic material such as polysilane and phthalopolymethine. Particularly, the amorphous silicon photoreceptors are preferably used in terms of long lives.

The electrostatic latent image is formed by uniformly charging the surface of the electrostatic latent image bearer and irradiating imagewise light onto the surface thereof with the electrostatic latent image former. The electrostatic latent image former includes at least a charger uniformly charging the surface of the electrostatic latent image bearer and an irradiator irradiating imagewise light onto the surface thereof.

The surface of the electrostatic latent image bearer is charged with the charger upon application of voltage.

The charger is not particularly limited, and can be selected in accordance with the purpose, such as an electroconductive or semiconductive rollers, bushes, films, known contact chargers with a rubber blade, and non-contact chargers using a corona discharge such as corotron and scorotron.

The surface of the electrostatic latent image bearer is irradiated with the imagewise light by the irradiator.

The irradiator is not particularly limited, and can be selected in accordance with the purpose, provided that the irradiator can irradiate the surface of the electrostatic latent image bearer with the imagewise light, such as reprographic optical irradiators, rod lens array irradiators, laser optical irradiators and a liquid crystal shutter optical irradiators. In the present invention, a backside irradiation method irradiating the surface of the electrostatic latent image bearer through the backside thereof may be used.

The development process is a process of forming a visual image by developing the electrostatic latent image with the toner of the present invention. The image developer is not particularly limited, and can be selected from known image developers, provided that the image developer can develop with the toner of the present invention. For example, an image developer containing the developer of the present invention and being capable of feeding the toner to the electrostatic latent image in contactor or not in contact therewith is preferably used, and an image developer including the toner container of the present invention is more preferably used. The image developer preferably has a stirrer stirring the developer of the present invention to be frictionally charged and a rotatable magnet roller. In the image developer, the toner and the carrier are mixed and stirred, and the toner is charged and held on the surface of the rotatable magnet roller in the shape of an ear to form a magnetic brush. Since the magnet roller is located close to the electrostatic latent image bearer (photoreceptor), a part of the toner is electrically attracted to the surface thereof. Consequently, the electrostatic latent image is developed with the toner to form a toner image thereon.

The transfer process is a process of transferring the toner image onto a recording medium, and it is preferable that the toner image is firstly transferred onto an intermediate transferer and secondly transferred onto a recording medium thereby. It is more preferable that two or more color toner images are firstly and sequentially transferred onto the intermediate transferer and the resultant complex full-color image is transferred onto the recording medium thereby.

The transferer preferably includes a first transferer transferring two or more visual color images onto an intermediate transferer and a second transferer transferring the resultant complex full-color image onto the recording medium. The intermediate transferer is not particularly limited, and can be selected from known transferers in accordance with the purposes, such as a transfer belt. Each of the first and second transferers preferably includes at least a transfer device chargeable to separate the visual image from the electrostatic latent image bearer toward the recoding medium. The transferer may include one, or two or more transfer devices.

The transferer device includes a corona transferer using a corona discharge, a transfer belt, a transfer roller, a pressure transfer roller, an adhesive roller, etc.

The recording medium is not particularly limited, and can be selected from known recording media (paper).

The fixing process is a process of fixing the toner image transferred onto the recording medium with a transferer, and each color toner may be fixed one by one or layered color toners may be fixed at the same time. The fixer is not particularly limited, can be selected in accordance with the purposes, and known heating and pressurizing means are preferably used. The heating and pressurizing means include a combination of a heating roller and a pressure roller, and a combination of a heating roller, a pressure roller and an endless belt, etc. The fixer of the present invention preferably includes a heater equipped with a heating element, a film contacting the heater and pressurizer contacting the heater through the film, wherein a recording material an unfixed image is formed on passes through between the film and pressurizer to fix the unfixed image upon application of heat. The heating temperature is preferably from 80 to 200° C. A known optical fixer may be used with or instead of the fixer in accordance with the purposes.

The discharge process is a process of preferably discharging the electrostatic latent image bearer with a discharger upon application of discharge bias. The discharger is not particularly limited, and can be selected from known dischargers, provided that the discharger can apply the discharge bias to the electrostatic latent image bearer, such as a discharge lamp.

The cleaning process is a process of preferably removing a toner remaining on the electrostatic latent image bearer with a cleaner. The cleaner is not particularly limited, and can be selected from known cleaners, provided that the cleaner can remove the toner remaining thereon, such as a magnetic brush cleaner, an electrostatic brush cleaner, a magnetic roller cleaner, a blade cleaner, a brush cleaner and web cleaner.

The toner recycle process is a process of preferably recycling a toner removed by the cleaner with a recycler. The recycler is not particularly limited, and known transporters can be used.

The control process is a process of preferably controlling the above-mentioned processes with a controller. The controller is not particularly limited, and can be selected in accordance with the purposes, provided the controller can control the above-mentioned means, such as a sequencer and a computer.

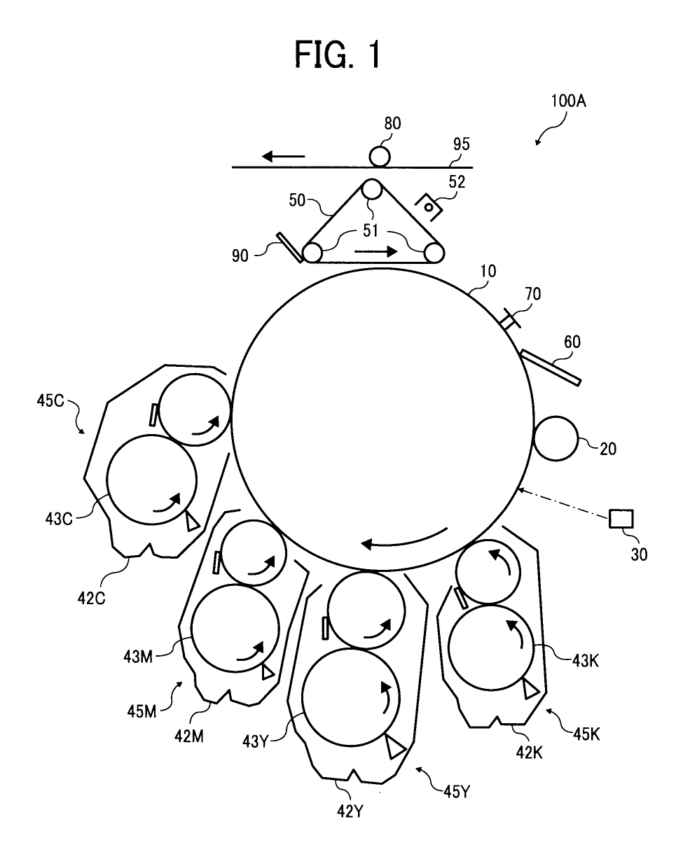

FIG. 1 is a schematic view illustrating an embodiment of the image forming apparatus of the present invention. An image forming apparatus 100A therein includes a photoreceptor drum 10 as an electrostatic latent image bearer, a charging roller as a charger 20, an irradiator (not shown), an image developer, an intermediate transferer 50, a cleaner 60 having a cleaning blade and a discharge lamp 70 as a discharger.

The intermediate transferer 50 is an endless belt suspended and extended by three rollers 51, and is transportable in the direction indicated by an arrow. The three rollers 51 partly work as a transfer bias roller capable of applying a predetermined first transfer bias to the intermediate transferer 50.

A cleaner 90 having a cleaning blade is located close thereto. Further, a transfer roller 80 capable of applying a transfer bias to a transfer paper 95 is located facing the intermediate transferer 50.

Around the intermediate transferer 50, corona chargers 52 charging the toner image thereon is located between a contact point of the photoreceptor 10 and the intermediate transferer 50 and a contact point of the intermediate transferer 50 and a transfer paper 95.

The image developer developing each color black (K), yellow (Y), magenta (M) and cyan (C) includes a developer feed roller 42 and a developing roller 43.

The charging roller 20 uniformly charges the photoreceptor 10. The irradiator (not shown) irradiates imagewise light (L) to the photoreceptor 10 to form an electrostatic latent image thereon. The electrostatic latent image formed thereon is developed with a toner fed from the image developer 40 to form a toner image thereon. The toner image is transferred (first transfer) onto the intermediate transferer 50 with a voltage applied from the corona charger 52, and is further transferred (second transfer) onto a transfer paper 95. The toner remaining on the photoreceptor 10 is removed by a cleaner 60, and the photoreceptor 10 is discharged by the discharge lamp 70.

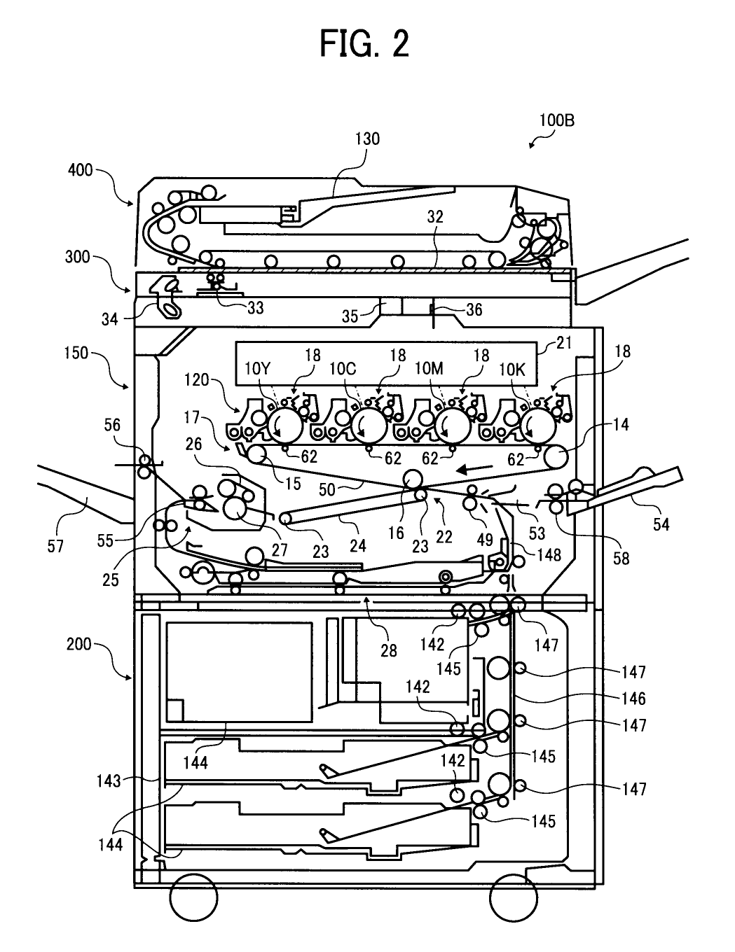

FIG. 2 is a schematic view illustrating another embodiment of the image forming apparatus for use in the present invention. An image forming apparatus (100B) therein is a tandem full-color image forming apparatus, including a duplicator 150, a paper feeding table 200, a scanner 300 and an automatic document feeder (ADF) 400.

The duplicator 150 includes an intermediate transferer 50 having the shape of an endless belt. An intermediate transferer 50 is suspended by three suspension rollers 14, 15 and 16 and rotatable in a direction indicated by an arrow.

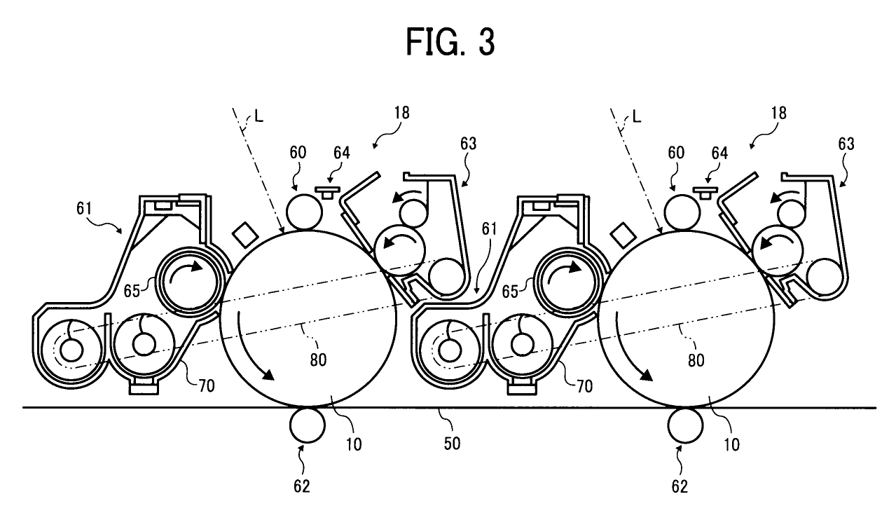

A cleaner 17 is located close to the suspension roller 15 to remove a residual toner on the intermediate transferer 50. Above the intermediate transferer 50, four image forming units 18 for yellow, cyan, magenta and black colors are located in line from left to right along a transport direction of the intermediate transferer 50 to form a tandem image forming developer 120. Each of the image forming units 18, as shown in FIG. 3, includes a photoreceptor drum 10; a charging roller 20 uniformly charging the photoreceptor drum 10; an image developer developing an electrostatic latent image formed on the photoreceptor drum 10 with each color developer black (K), yellow (Y), magenta (M) and cyan (C) to form a toner image; a transfer roller (80) transferring each color toner image onto the intermediate transferer 50; a cleaner 60 and a discharge lamp 70.

An irradiator 30 is located close to the tandem image forming developer 120. The irradiator 30 irradiates the photoreceptor drum 10 with imagewise light (L) to form an electrostatic latent image.

On the opposite side of the tandem color image developer 120 across the intermediate transferer 50, a second transferer 22 is located. The second transferer 22 includes a an endless second transfer belt 24 suspended by a pair of rollers 23, and a recording paper fed on the second transfer belt 24 and the intermediate transferer 50 ca contact each other.

A fixer 25 fixing a transferred image on the sheet is located close to the second transferer 22. The fixer 25 includes an endless fixing belt 26 and a pressure roller 27 pressing the fixing belt 26.

In addition, a sheet reverser 28 reversing the sheet to form an image on both sides thereof is located close to the second transferer 22 and the fixer 25.

Full-color image formation using in the image forming apparatus 100B will be explained. An original is set on a table 130 of the ADF 400 to make a copy, or on a contact glass 32 of the scanner 300 and pressed with the ADF 400. When a start switch (not shown) is put on, a first scanner 33 and a second scanner 34 scans the original after the original set on the table 130 of the ADF 400 is fed onto the contact glass 32 of the scanner 300, or immediately when the original set thereon. The first scanner 33 emits light to the original and reflects reflected light therefrom to the second scanner 34. The second scanner further reflects the reflected light to a reading sensor 36 through an imaging lens 35 to read the color original (color image) as image information of black, yellow, magenta and cyan.

Further, after each color electrostatic latent image is formed on the photoreceptor drum 10 by the irradiator 30 based on image information of the each color, the each color electrostatic latent image is developed with a developer fed from each color image developer to form each color toner images. The each color toner image is sequentially transferred (first transfer) onto the intermediate transferer 50 being rotated by the suspension rollers 14, 15 and 16 to form a multiple toner image thereon.

On the other hand, one of paper feeding rollers 142 of paper feeding table 200 is selectively rotated to take a sheet out of one of multiple-stage paper cassettes 144 in a paper bank 143. A separation roller 145 separates sheets one by one and feed the sheet into a paper feeding route 146, and a feeding roller 147 feeds the sheet into a paper feeding route 148 to be stopped against a registration roller 49. Alternatively, a paper feeding roller 150 is rotated to take a sheet out of a manual feeding tray 51, and a separation roller 52 separates sheets one by one and feed the sheet into a paper feeding route 53 to be stopped against the registration roller 49. The registration roller 49 is typically earthed, and may be biased to remove a paper dust from the sheet.

Then, in timing with the multiple toner image on the intermediate transferer 50, the registration roller 49 is rotated to feed the sheet between the intermediate transferer 50 and the second transferer 22, and the second transferer transfers (second transfer) the multiple toner image onto the recording paper.

The recording paper the multiple toner image is transferred on is fed by the second transferer 22 to the fixer 25. The fixer 25 fixes the image thereon upon application of heat and pressure, and the sheet is discharged by a discharge roller 56 onto a catch tray 57 through a switch-over click 55. Alternatively, the switch-over click 55 feeds the sheet into the sheet reverser 28 reversing the sheet to a transfer position again to form an image on the backside of the sheet, and then the sheet is discharged by the discharge roller 56 onto the catch tray 57.

The intermediate transferer 50 after transferring an image is cleaned by the cleaner 17 to remove a residual toner thereon after the image is transferred.

Having generally described this invention, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

### Unmodified Polyester Resin A

67 parts of an adduct of bisphenol A with 2 moles of ethyleneoxide, 84 parts of an adduct of bisphenol A with 3 moles of propyleneoxide, 274 parts terephthalic acid and 2 parts of dibutyltinoxide were reacted in a reactor vessel including a cooling pipe, a stirrer and a nitrogen inlet pipe for 10 hrs at a normal pressure and 230° C. Next, the mixture was depressurized by 10 to 15 mmHg and reacted for 6 hrs to prepare a polyester resin A. The polyester A had a number-average molecular weight of 2,300, a weight-average molecular weight of 7,000, a Tg of 65° C., an acid value of 20 mg KOH/g and a hydroxyl value of 40 mg KOH/g.

### —Unmodified Polyester Resin B—

77 parts of an adduct of bisphenol A with 2 moles of ethyleneoxide, 74 parts of an adduct of bisphenol A with 3 moles of propyleneoxide, 289 parts terephthalic acid and 2 parts of dibutyltinoxide were reacted in a reactor vessel including a cooling pipe, a stirrer and a nitrogen inlet pipe for 8 hrs at a normal pressure and 230° C. Next, the mixture was depressurized by 10 to 15 mm Hg and reacted for 5 hrs to prepare a polyester resin B. The polyester B had a number-average molecular weight of 2,100, a weight-average molecular weight of 5,600, a Tg of 62° C., an acid value of 35 mg KOH/g and a hydroxyl value of 95 mg KOH/g.

### —Preparation of Masterbatch—

1,000 parts of water, 540 parts of carbon black Printex 35 from Degussa A.G. having a DBP oil absorption of 42 ml/100 mg and a pH of 9.5, 1,200 parts of the polyester resin A were mixed by a Henschel Mixer from Mitsui Mining Co., Ltd. After the mixture was kneaded by a two-roll mill having a surface temperature of 150° C. for 30 min, the mixture was extended by applying pressure, cooled and pulverized by a pulverizer from Hosokawa Micron Limited to prepare a masterbatch.

### <Preparation of Toner A>

364 parts of the unmodified polyester resin B, 124 parts of wax B (a paraffin wax having a melting point of 53° C. from Nippon Seiro Co., Ltd.) and 947 parts of ethyl acetate were mixed in a reaction vessel including a stirrer and a thermometer. The mixture was heated to have a temperature of 80° C. while stirred. After the temperature of 80° C. was maintained for 5 hrs, the mixture was cooled to have a temperature of 30° C. in an hour.

Next, 500 parts of the masterbatch and 500 parts of ethyl acetate were added to the mixture and mixed for 1 hr to prepare a material solution.

1,324 parts of the material solution were transferred into another vessel, and the carbon black and carnauba wax therein were dispersed by a beads mill (Ultra Visco Mill from IMECS CO., LTD.) for 3 passes at a liquid feeding speed of 1 kg/hr and a peripheral disc speed of 6 m/sec using zirconia beads having diameter of 0.5 mm for 80% by volume to prepare a wax dispersion.

Next, 1,324 parts of an ethyl acetate solution of the unmodified polyester resin B having a concentration of 65% were added to the wax dispersion. 1.5 parts of Clayton APA from Southern Clay Products, Inc. were added as a charge controlling agent to 200 parts of the wax dispersion subjected to one pass using the Ultra Visco Mill under the same conditions to prepare a mixture. The mixture was stirred at 7,000 rpm for 60 min with T.K. Homodisper from Tokushu Kika Kogyo Co., Ltd. to prepare a toner constituents dispersion.

682 parts of an adduct of bisphenol A with 2 moles of ethyleneoxide, 81 parts of an adduct of bisphenol A with 2 moles of propyleneoxide, 283 parts terephthalic acid, 22 parts of trimellitic acid anhydride and 2 parts of dibutyltinoxide were mixed and reacted in a reactor vessel including a cooling pipe, a stirrer and a nitrogen inlet pipe for 8 hrs at a normal pressure and 230° C. Further, after the mixture was depressurized by 10 to 15 mm Hg and reacted for 5 hrs to prepare an intermediate polyester resin.

The intermediate polyester resin had a number-average molecular weight of 2,100, a weight-average molecular weight of 9,500, a Tg of 55° C. and an acid value of 0.5 mg KOH/g and a hydroxyl value of 51 mg KOH/g.

Next, 410 parts of the intermediate polyester resin, 89 parts of isophoronediisocyanate and 500 parts of ethyl acetate were reacted in a reactor vessel including a cooling pipe, a stirrer and a nitrogen inlet pipe for 5 hrs at 100° C. to prepare a prepolymer. The prepolymer included a free isocyanate in an amount of 1.53% by weight.

170 parts of isophoronediamine and 75 parts of methyl ethyl ketone were reacted at 50° C. for 5 hrs in a reaction vessel including a stirrer and a thermometer to prepare a ketimine compound. The ketimine compound had an amine value of 418 mg KOH/g. 749 parts of the toner constituents dispersion 1,115 parts of the prepolymer and 2.5 parts of the ketimine compound were mixed in a vessel by a T.K. Homomixer from Tokushu Kika Kogyo Co., Ltd. at 5,000 rpm for 1 min to prepare an oil phase mixed liquid.

683 parts of water, 11 parts of a sodium salt of an adduct of a sulfuric ester with ethyleneoxide methacrylate (ELEMINOL RS-30 from Sanyo Chemical Industries, Ltd.), 83 parts of styrene, 83 parts of methacrylate, 110 parts of butylacrylate and 1 part of persulfate ammonium were mixed in a reactor vessel including a stirrer and a thermometer, and the mixture was stirred for 15 min at 400 rpm to prepare a white emulsion therein. The white emulsion was heated to have a temperature of 75° C. and reacted for 5 hrs. Further, 30 parts of an aqueous solution of persulfate ammonium having a concentration of 1% by weight were added thereto and the mixture was reacted for 5 hrs at 75° C. to prepare a particulate resin dispersion.

The volume-average particle diameter of the particulate resin included in particulate resin dispersion was 105 nm when measured by MICROTRAC ultra fine particle diameter distribution measurer UPA-EX150 using laser Doppler method from Nikkiso Co., Ltd. In addition, the particulate resin dispersion was partly dried to isolate the resin, and the resin had a glass transition temperature of 59° C. and weight-average molecular weight of 150,000.

990 parts of water, 83 parts of the [particulate dispersion liquid], 37 parts of an aqueous solution of sodium dodecyldiphenyletherdisulfonate having a concentration of 48.5% (ELEMINOL MON-7 from Sanyo Chemical Industries, Ltd.), 135 parts of an aqueous solution having a concentration of 1% by weight of a polymer dispersant carboxymethylcellulose sodium Selogen BS-H-3 from DAI-ICHI KOGYO SEIYAKU CO., LTD. and 90 parts of ethyl acetate were mixed and stirred to prepare an aqueous medium.

867 parts of the oil phase mixed liquid were mixed with 1,200 parts of the aqueous medium by T.K. Homomixer at 13,000 rpm for 20 min to prepare a dispersion (an emulsified slurry).

Next, the emulsified slurry was placed in a vessel including a stirrer and a thermometer, and after a solvent was removed therefrom at 30° C. for 8 hrs, the slurry was aged at 45° C. for 4 hrs to prepare a dispersion slurry.

The dispersion slurry had a volume-average particle diameter of 5.1 μm and a number-average particle diameter of 4.9 μm when measured by Multisizer III from Beckman Coulter. Inc.

After 100 parts of the dispersion slurry was filtered under reduced pressure, 100 parts of ion-exchange water were added to the filtered cake and mixed by T.K. Homomixer at 12,000 rpm for 10 min, and the mixture was filtered.

A phosphoric acid including phosphorus in an amount of 10% by weight were added to the filtered cake to have a pH of 3.7 and mixed by T.K. Homomixer at 12,000 rpm for 10 min, and the mixture was filtered.

Further, 300 parts of ion-exchange water were added to the filtered cake and mixed by T.K. Homomixer at 12,000 rpm for 10 min, and the mixture was filtered. This operation was repeated again to prepare a final filtered cake.

The final filtered cake was dried by an air drier at 45° C. for 48 hrs, and sieved with a mesh having an opening of 75 μm to prepare parent toner particles 1.

Then, 1.5 parts of hydrophobic silica and 0.7 parts of hydrophobized titanium oxide were mixed with 100 parts of the parent toner particles by Henschel Mixer from Mitsui Mining Co. to prepare a toner A.

### <Preparation of Toner B>

The preparation of the toner A was repeated except for mixing 350 parts of the unmodified polyester resin B, 138 parts of the wax B and 947 parts of ethyl acetate in a reaction vessel including a stirrer and a thermometer.

### <Preparation of Toner C>

The preparation of the toner A was repeated except for mixing 364 parts of the unmodified polyester resin B, 124 parts of a wax D (a paraffin wax having a melting point of 85° C. from Nippon Seiro Co., Ltd.) and 947 parts of ethyl acetate in a reaction vessel including a stirrer and a thermometer.

### <Preparation of Toner D>

The preparation of the toner A was repeated except for mixing 350 parts of the unmodified polyester resin B, 138 parts of the wax D and 947 parts of ethyl acetate in a reaction vessel including a stirrer and a thermometer.

### <Preparation of Toner E>

The preparation of the toner A was repeated except for mixing 378 parts of the unmodified polyester resin B, 110 parts of a wax HNP-11 (a paraffin wax having a melting point of 70° C. from Nippon Seiro Co., Ltd.) and 947 parts of ethyl acetate in a reaction vessel including a stirrer and a thermometer.

### <Preparation of Toner F>

The preparation of the toner A was repeated except for mixing 378 parts of the unmodified polyester resin B, 110 parts of a wax HNP-9 (a paraffin wax having a melting point of 76.1° C. from Nippon Seiro Co., Ltd.) and 947 parts of ethyl acetate in a reaction vessel including a stirrer and a thermometer.

### <Preparation of Toner G>

The preparation of the toner A was repeated except for mixing 378 parts of the unmodified polyester resin B, 110 parts of the wax D and 947 parts of ethyl acetate in a reaction vessel including a stirrer and a thermometer.

### <Carrier Preparation Example>

The following materials were dispersed by a homomixer for 10 min to prepare a solution for forming a coated film of an acrylic resin and a silicone resin including a particulate alumina.

| | |
|---|---|
| Acrylic resin solution | 21.0 |
| (including a solid content of 50% by weight) | |
| Guanamine solution | 6.4 |
| (including a solid content of 70% by weight) | |
| Particulate alumina | 7.6 |
| (having a particle diameter of 0.3 μm | |
| and a resistivity of 10¹⁴ Ω · cm) | |
| Silicone resin solution | 65.0 |
| (including a solid content SR2410 of 23% by | |
| weight from Dow Corning Toray Silicone Co., Ltd.) | |
| Amino silane | 0.3 |
| (including a solid content SH6020 from Dow | |
| Corning Toray Silicone Co., Ltd.) | |
| Toluene | 60 |
| Butyl cellosolve | 60 |

The solution for forming a coated film was coated on a calcined ferrite powder [(MgO)_{1.8}(MnO)_{49.5}(Fe₂O₃)_{48.0} having an average particle diameter of 50 μm as a core material] by SPIRA COTA from OKADA SEIKO CO., LTD to have a thickness of 0.15 μm, and dried. The dried material was calcined in an electric oven at 150° C. for 1 hr. The calcined material was cooled and sieved with a sieve having an opening of 106 μm to prepare a carrier.

### <Developer>

6 parts by weight of the toner and 94 parts by weight of the carrier were stirred by Tubular Mixer T2F from Willy A. Bachofen AG Maschinenfabrik for 5 min to prepare a developer.

### <<Evaluation Methods>>

### <Loss on Heat>

A loss on heat of the developer was measured by TGA device model Q5000IR from TA Instruments when heated until having a predetermined temperature at 10° C./min under a nitrogen atmosphere and held for 10 min at the predetermined temperature.

### <DSC>

A DSC curve of the developer was measured by DSC-60 from Shimadzu Corp. at a rate of temperature increase of 10° C./min under a nitrogen atmosphere.

From the DSC curve, a shoulder coming from the release agent thereon when heated secondly was selected using an analysis program in the DSC-60 system to determine the end temperature.

### <Inner Contamination>

Each of the developers was used in a Modified digital color imagio Neo C600 from Ricoh Company, Ltd.

After 100,000 monochrome images of an image chart having an image area of 50% were produced, contaminations around the fixer and paper discharger was visually observed.
◯: not contaminated
Δ: slightly contaminated, but the images not contaminated
x: contaminated, and images were also contaminated

### <Paper Separativeness>

This was evaluated by the number of jams when 1,000 images were continuously produced on copy paper <55> from NBS Corp.
◯: None
Δ: 1 to 3 times
x: 4 times or more

### Example 1

The developer including the toner A was used in the modified digital color imagio Neo C600 from Ricoh Company, Ltd., and images were produced at 285 mm/sec to evaluate the inner contamination and the paper separativeness.

### Example 2

The evaluations in Example 1 was repeated except for including the toner B in the developer.

### Example 3

The evaluations in Example 1 was repeated except for including the toner C in the developer.

### Example 4

The evaluations in Example 1 was repeated except for including the toner D in the developer.

### Comparative Example 1

The evaluations in Example 1 was repeated except for including the toner E in the developer.

### Comparative Example 2

The evaluations in Example 1 was repeated except for including the toner F in the developer.

### Comparative Example 3

The evaluations in Example 1 was repeated except for including the toner G in the developer.

Table 1 shows the results of loss on heat, n-paraffin ratio, inner contamination and paper separativeness of the toners A to G.

Table 2 shows the results of inner contamination and paper separativeness thereof when images were produced at 240 mm/sec.

The toner of the present invention has better inner contamination resistance and paper separativeness than the toners of Comparative Examples, particularly when images are produced at 250 mm/sec or faster.

TABLE 1

| | | | LoH | DLoh | n-p | ET | | |
|---|---|---|---|---|---|---|---|---|
| | Toner | Wax | (%) | (%) | (%) | (° C.) | IC | Sepa |
| Example 1 | A | B | 0.09 | 0.22 | 3.2 | 91 | ◯ | ◯ |
| Example 2 | B | B | 0.10 | 0.25 | 3.6 | 91 | ◯ | ◯ |
| Example 3 | C | D | 0.09 | 0.43 | 3.0 | 87 | ◯ | Δ |
| Example 4 | D | D | 0.10 | 0.47 | 3.4 | 87 | ◯ | ◯ |
| Comparative | E | HNP-11 | 2.70 | 1.28 | 3.8 | 71 | X | ◯ |
| Example 1 | | | | | | | | |
| Comparative | F | HNP-9 | 0.27 | 1.33 | 3.5 | 77 | X | ◯ |
| Example 2 | | | | | | | | |
| Comparative | G | D | 0.46 | 0.08 | 2.7 | 87 | ◯ | X |
| Example 3 | | | | | | | | |

TABLE 2

| | Toner | n-p (%) | IC | Sepa |
|---|---|---|---|---|
| Example 1 | A | 3.2 | ◯ | ◯ |
| Example 2 | B | 3.6 | ◯ | ◯ |
| Example 3 | C | 3.0 | ◯ | ◯ |
| Example 4 | D | 3.4 | ◯ | ◯ |
| Comparative | E | 3.8 | X | ◯ |
| Example 1 | | | | |
| Comparative | F | 3.5 | X | ◯ |
| Example 2 | | | | |
| Comparative | G | 2.7 | ◯ | ◯ |
| Example 3 | | | | |

LoH: Loss on heat at 165° C.
DLoH: Difference of loss on heat (180° C. − 165° C.)
n-p: Content of n-paraffin
ET: Peak end temperature coming from release agent
IC: Inner contamination
Sepa: Separativeness

This application claims priority and contains subject matter related to Japanese Patent Application No. 2008-244323, filed on Sep. 24, 2008, the entire contents of which are hereby incorporated by reference.

Having now fully described the invention, it will be apparent to one of ordinary skill in the art that many changes and modifications can be made thereto without departing from the spirit and scope of the invention as set forth therein.

What is claimed as new and desired to be secured by Letters Patent of the United States is:

1. A toner for electrophotography, comprising:
a release agent;
a binder resin;
a colorant; and
an external additive,
wherein the binder resin is a polyester resin, and wherein the toner has a loss on heat not greater than 0.40% by weight at 165° C. and a difference between a loss on heat at 200° C. and the loss on heat at 165° C. not greater than 0.50% by weight, and includes a n-paraffin in an amount not less than 3% by weight.

2. The toner for electrophotography of claim 1, wherein the release agent is a paraffin wax and a peak end temperature in a DSC chart coming therefrom is from 80 to 95° C.

3. The toner for electrophotography of claim 1, wherein the toner is granulated in an aqueous medium.

4. A two-component developer, comprising:
a magnetic particulate carrier; and
the toner according to claim 1,
wherein the toner has an average particle diameter of from 3 to 6 μm.

5. An image forming method, comprising:
forming latent images on plural electrostatic latent image bearers;
developing the latent images with the two-component developers according to claim 4, each comprising a different color toner to form toner images each having a different color on each of the plural electrostatic latent image bearers;
transferring the toner images onto an image forming substrate through an intermediate transferer; and
fixing the toner images on the image forming substrate,
wherein the image forming substrate is fed at a speed of 250 mm/sec.
